(19) United States
(12) Patent Application Publication
(10) Pub. No.: US 2026/0366366 A1
(43) Pub. Date: Nov. 19, 2026

(54) RETRACTABLE GATE BARRIER STRUCTURE

(71) Applicant: GUANGZHOU TUSUNNY HOME PRODUCTS CO., LTD, Guangzhou (CN)

(72) Inventor: Hongjuan WANG, Guangzhou (CN)

(73) Assignee: GUANGZHOU TUSUNNY HOME PRODUCTS CO., LTD, Guangzhou (CN)

(21) Appl. No.: 19/238,713

(22) Filed: Jun. 16, 2025

(30) Foreign Application Priority Data
May 19, 2025 (CN) 202510645432.6

(51) Int. Cl. E06B 9/08; A46B 5/00; A46B 15/00; E06B 9/13; E06B 9/60; E06B 9/00

(52) U.S. Cl. CPC E06B 9/08; A46B 5/0012; A46B 15/0053; E06B 9/13; E06B 9/60; E06B 2009/002

(57) ABSTRACT

The present disclosure relates to the technical field of gate barriers, and specifically discloses a retractable gate barrier structure. The retractable gate barrier structure comprises: an upper fixed seat and a lower fixed seat; a rotating drum, arranged between the upper fixed seat and the lower fixed seat, configured to rotate about an axis of the rotating drum; a partition cloth, wound around the rotating drum, wherein a torsion spring is arranged in the rotating drum; a housing, arranged on an outer side of the rotating drum, wherein the upper fixed seat and the lower fixed seat are respectively mounted at two ends of the housing; wherein the housing is provided with an opening, and a retraction brush assembly is mounted at the opening; the partition cloth, after retraction around the outer side of the rotating drum, is located in an inner cavity of the housing.

### CROSS-REFERENCE TO RELATED APPLICATIONS

This application claims priority to Chinese Patent Application No. 202510645432.6, filed on May 19, 2025, which is incorporated herein by reference in its entirety.

### TECHNICAL FIELD

The present disclosure relates to the technical field of gate barriers, particularly to a retractable gate barrier structure.

### BACKGROUND

As a common spatial partitioning device, telescopic gate barriers are primarily used in residential interiors or garden landscapes. The device realizes physical partitioning through a retractable structure, enabling quick division of temporary activity areas according to usage requirements. In indoor scenarios, the flexible characteristics of the telescopic gate barrier support dynamic partitioning of spaces such as living rooms and corridors; in outdoor garden environments, the telescopic gate barrier effectively delineates functional garden zones.

In related art, a telescopic gate barrier includes fixed seats, a rotating drum, and a partition cloth. Two fixed seats are provided, and are positioned at both ends of the rotating drum, and the rotating drum is rotationally connected to the fixed seats. One end of the partition cloth is fixed to the rotating drum, and the partition cloth is wound around the rotating drum. A torsion spring is arranged in the rotating drum. When a user pulls the free end of the partition cloth, the rotating drum rotates, driving the torsion spring to rotate and generate a return torque. After the free end of the partition cloth is pulled a certain distance and fixed, the partition cloth becomes taut under the return torque of the torsion spring. When the free end of the partition cloth is released, the rotating drum rotates in the opposite direction under the return torque of the torsion spring, enabling automatic retraction of the partition cloth.

During practical use, it is observed that when the partition cloth of a retractable gate barrier is extended for prolonged display, dust readily accumulates on the surface of the partition cloth. Such dust accumulation impairs information presentation on the surface of the partition cloth. Furthermore, partition cloths with rubber-coated surfaces particularly tend to develop static electricity during display. Static electricity causes the surface of the partition cloth to attract dust, and manual removal of such adhered dust is cumbersome.

### SUMMARY

An objective of at least one embodiment of the present disclosure is to provide a retractable gate barrier structure in order to overcome the defects in the prior art.

To achieve the above objective, the technical solution adopted by the present disclosure is as follows:

A retractable gate barrier structure, comprising:
an upper fixed seat and a lower fixed seat;
a rotating drum, arranged between the upper fixed seat and the lower fixed seat, configured to rotate about an axis of the rotating drum;
a partition cloth, wound around the rotating drum, wherein a torsion spring is arranged in the rotating drum, and the torsion spring is configured to drive the rotating drum to rotate about the axis of the rotating drum in one direction, so that the rotating drum is arranged to retract the partition cloth;
a housing, arranged on an outer side of the rotating drum, wherein the upper fixed seat and the lower fixed seat are respectively mounted at two ends of the housing; and the housing is provided with an opening, and a retraction brush assembly is mounted at the opening;
the partition cloth, after retraction around the outer side of the rotating drum, is located in an inner cavity of the housing, and one end of the partition cloth extends out from the opening of the housing and passes through the retraction brush assembly; and
when the partition cloth extends out from the housing or retracts into the housing, the retraction brush assembly is arranged to sweep two side surfaces of the partition cloth to remove dust and dissipate static electricity from the surface of the partition cloth.

Further, the retraction brush assembly comprises:
a brush housing, mounted at the opening of the housing, wherein the brush housing is provided with a first guide outlet and a second guide outlet;
a first brush, mounted on two sides of an inner wall of the first guide outlet, wherein when the partition cloth passes through the first guide outlet, ends of the first brush contact and sweep two side surfaces of the partition cloth to remove dust from the two side surfaces of the partition cloth;
a second brush, mounted on two sides of an inner wall of the second guide outlet, wherein when the partition cloth passes through the second guide outlet, ends of the second brush contact and sweep the two side surfaces of the partition cloth to dissipate static electricity from the two side surfaces of the partition cloth;
an adjustment assembly, arranged on the brush housing, configured to adjust a distance between the two second brushes on the inner wall of the second guide outlet; and
a dust suction assembly, mounted on the lower fixed seat, wherein the dust section assembly is in communication with an inner cavity of the brush housing.

Further, the first brush is an anti-static nylon brush; and the second brush comprises a metal backplate and a carbon fiber brush mounted on the metal backplate, wherein the metal backplate is grounded via a metal component.

Further, the adjustment assembly comprises:
an adjustment bolt, penetrating through a threaded hole on the brush housing and facing a back surface of the second brush;
a guide rail, mounted at two ends of the inner wall of the second guide outlet;
a slider, fixed at the end of the second brush and slidably engaged with a guide rail groove on the guide rail;
a spring, wherein one end of the spring is fixedly connected to a cavity wall of the inner cavity of the brush housing, and another end of the spring is connected to the slider;
when rotating the adjustment bolts on two sides of the brush housing in a forward direction, ends of the adjustment bolts are arranged to abut against a back surface of the second brush, so that the two second brushes in the second guide outlet close to each other and stretch the spring; and
when rotating the adjustments bolts on two sides of the brush housing in a reverse direction, the ends of the adjustment bolts are separated from the back surface of the second brush, and the stretched spring tends to reset and drive the two second brushes to move away from each other.

Further, the dust suction assembly comprises a suction pump arranged in the lower fixed seat, and a suction pipe connected to the suction pump, and an end of the suction pipe is in communication with the inner cavity of the brush housing.

Further, the retractable gate barrier structure further comprising: an adjustment device, wherein the adjustment device comprises an adjustment rod, the torsion spring and an adjustment mechanism, one end of the torsion spring is connected to the rotating drum, and another end of the torsion spring is connected to the adjustment rod; and

Further, the adjustment mechanism comprises:
an adjustment ratchet wheel, connected to the adjustment rod;
an adjustment pawl, matched with the adjustment ratchet wheel; the lower fixed seat is provided with a mounting cavity, the adjustment ratchet wheel and the adjustment pawl are both arranged in the mounting cavity, and the adjustment ratchet wheel is configured to rotate about an axis of the adjustment ratchet wheel; and the lower fixed seat is provided with a rotating rod protruding therefrom, and the adjustment pawl is sleeved on the rotating rod via a through-hole formed in the adjustment pawl; and
a first abutting spring, configured to bias the adjustment pawl into engagement with a ratchet groove of the adjustment ratchet wheel.

Further, the retractable gate barrier structure further comprising a locking device, wherein the locking device is arranged in the upper fixed seat, and the locking device comprises:
a locking ratchet, connected to an upper end of the rotating drum;
a locking pawl, matched with the locking ratchet; and the upper fixed seat is provided with a rotating shaft protruding therefrom, and the locking pawl is sleeved on the rotating shaft via a through-hole formed in the locking pawl; and
a second abutting spring, configured to bias the locking pawl into engagement with a ratchet groove of the locking ratchet.

Further, the locking device further comprises an unlocking assembly, the unlocking assembly comprises a push-off turntable and a push-off protrusion arranged on a side of the push-off turntable, and the push-off turntable is configured to rotate about an axis of the push-off turntable; and

Further, the upper fixed seat is provided with a protective shell, the protective shell is provided with a placement cavity accommodating a locking knob, and the locking knob is connected to the push-off turntable.

The beneficial effects of the present disclosure are as follows: 1. The housing of the present disclosure is provided with an opening, and a retraction brush assembly is mounted at the opening. When the partition cloth extends out from the housing or retracts into the housing, the retraction brush assembly is arranged to sweep two side surfaces of the partition cloth to remove dust and dissipate static electricity from the surface of the partition cloth. By providing the retraction brush assembly (comprising a first brush and a second brush), the brushes automatically clean both side surfaces of the partition cloth during retraction or extension of the partition cloth, removing accumulated dust and neutralizing static electricity, thereby significantly reducing dust adhesion. The first brush (an anti-static nylon brush) physically removes dust, while the second brush (a carbon fiber brush with a metal backplate) dissipates static electricity via grounding, thereby enhancing cleaning efficacy through dual mechanisms.

2. The grounded metal backplate of the second brush rapidly discharges static electricity from the surface of the partition cloth, preventing electrostatic dust attraction. This design is particularly suitable for static-prone materials like rubber-coated partition cloths. The conductive properties of the carbon fiber brush further improve static electricity dissipation efficiency, reducing dust adhesion at the source.

3. The adjustment assembly, via cooperation between the springs and the adjustment bolts, flexibly adjusts the spacing between the second brushes to accommodate partition cloths of varying thicknesses or materials. This thereby ensures tight contact between the brushes and the cloth surface, enhancing cleaning and improving the static electricity dissipation effect.

4. The dust collection assembly (comprising a suction pump and a suction pipe) sucks in and centrally collects dust dislodged by the brushes, preventing secondary dispersion of dust, maintaining environmental cleanliness, and reducing manual cleaning frequency.

The present disclosure retains the flexible partitioning function of conventional retractable gate barriers while significantly enhancing practicality and durability of the product through automated cleaning and static electricity dissipation design, particularly suitable for scenarios requiring long-term display or operating in high-dust environments.

### BRIEF DESCRIPTION OF THE DRAWINGS

In order to more clearly illustrate the technical solutions in the embodiments of the present disclosure, the drawings needed to be used in the description of the embodiments will be briefly introduced below. Obviously, the drawings in the following description are some embodiments of the present disclosure, and for a person of ordinary skill in the art, other drawings can also be obtained based on these drawings without exerting creative efforts.

FIG. 1 is a perspective view of the present disclosure.

FIG. 2 is a partial enlarged view of section A in FIG. 1;

FIG. 3 is a perspective view of the present disclosure from another angle;

FIG. 4 is a schematic structural diagram of the partition cloth during deployment according to the present disclosure;

FIG. 5 is an installation schematic view of the retraction brush assembly on the housing according to the present disclosure;

FIG. 6 is a side schematic view of the retraction brush assembly according to the present disclosure;

FIG. 7 is a cross-sectional schematic view taken along line D-D in FIG. 6;

FIG. 8 is a cross-sectional schematic view taken along line E-E in FIG. 7;

FIG. 9 is an enlarged view of section F in FIG. 8;

FIG. 10 is an exploded view of the lower fixed seat according to the present disclosure;

FIG. 11 is an exploded view of the upper fixed seat according to the present disclosure;

FIG. 12 is a cross-sectional view according to the present disclosure;

FIG. 13 is a partial enlarged view of section B in FIG. 12;

FIG. 14 is a partial enlarged view of section C in FIG. 12;

FIG. 15 is a perspective view of the locking device according to the present disclosure;

FIG. 16 is a top view of the locking device according to the present disclosure.

### DETAILED DESCRIPTION OF THE EMBODIMENTS

The technical solutions of the present disclosure will be clearly and completely described below in conjunction with the accompanying drawings. Obviously, the described embodiments are only a part of the embodiments of the present disclosure, rather than all of them. Based on the embodiments of the present disclosure, all other embodiments obtained by those of ordinary skilled in the art without creative efforts shall fall within the protection scope of the present disclosure.

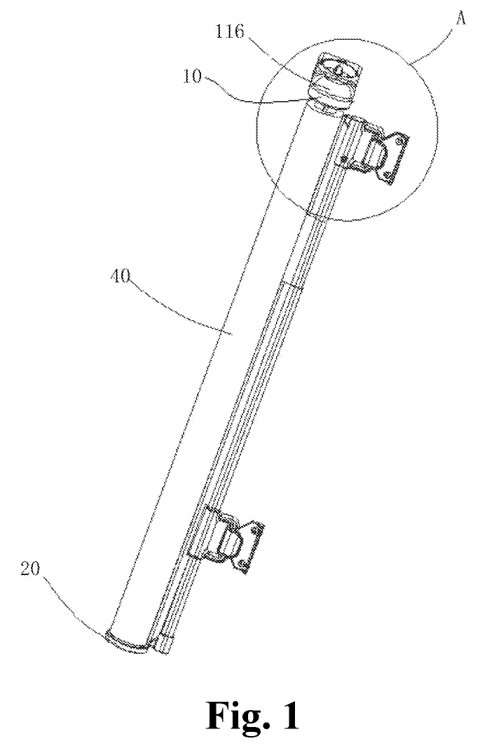

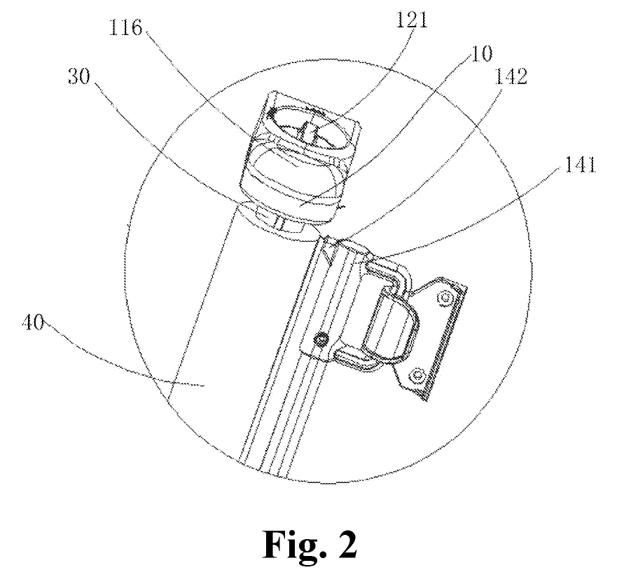

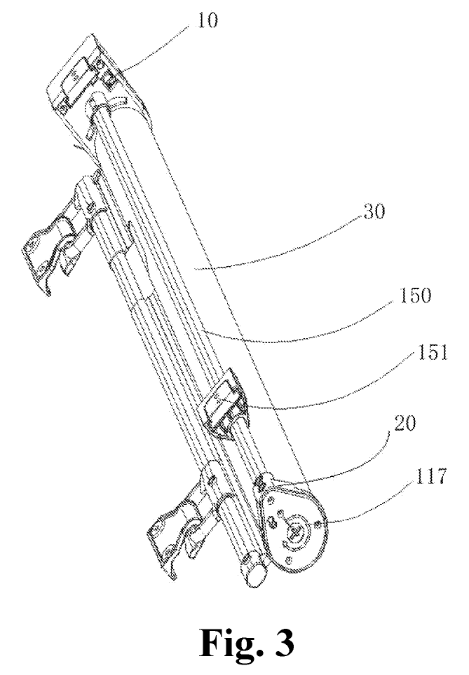

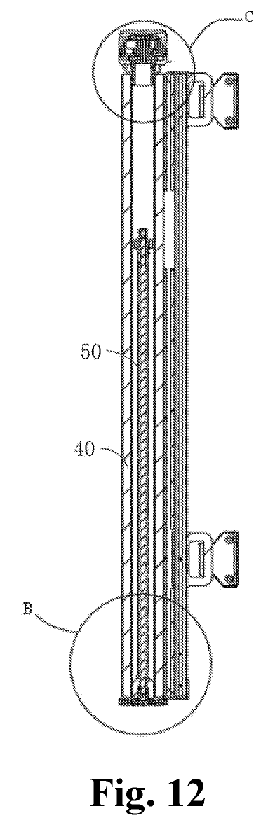

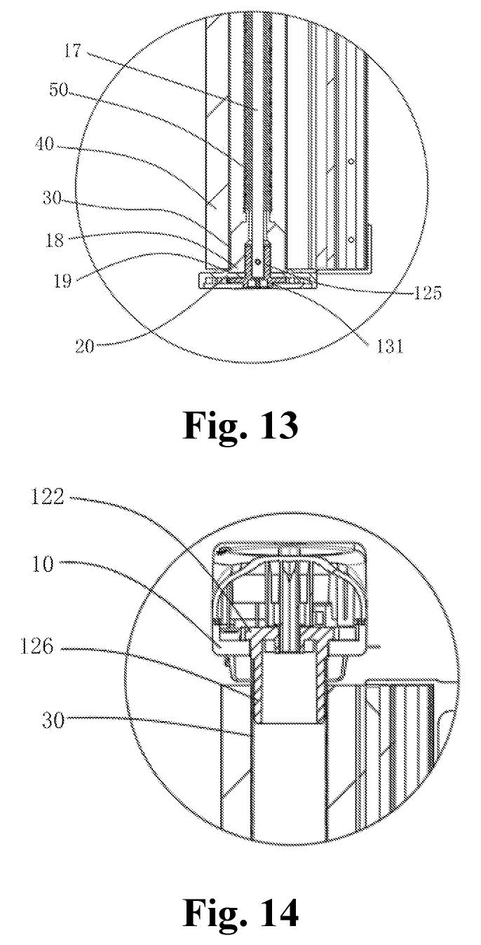

Referring to FIGS. 1-3, FIGS. 12 and 13, a retractable gate barrier structure, comprising: an upper fixed seat 10 and a lower fixed seat 20; a rotating drum 30, arranged between the upper fixed seat 10 and the lower fixed seat 20, configured to rotate about an axis of the rotating drum 30; a partition cloth 40, wound around the rotating drum 30, wherein a torsion spring 50 is arranged in the rotating drum 30, and the torsion spring 50 is configured to drive the rotating drum 30 to rotate about the axis of the rotating drum 30 in one direction, so that the rotating drum 30 is arranged to retract the partition cloth 40.

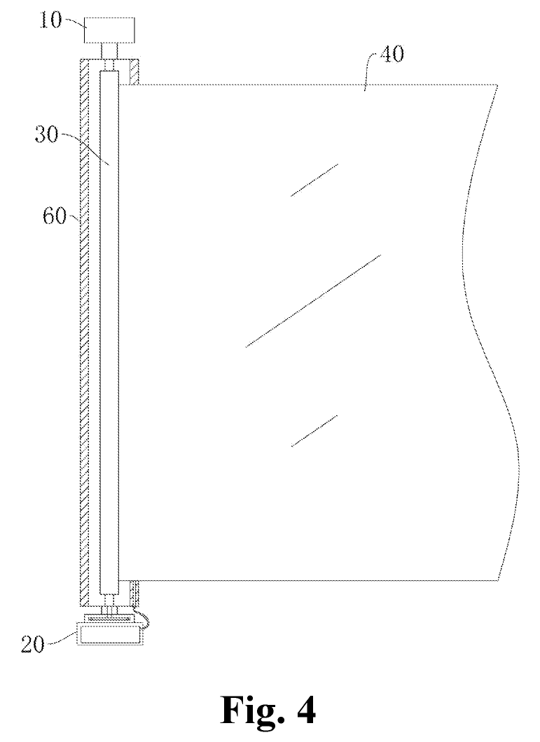

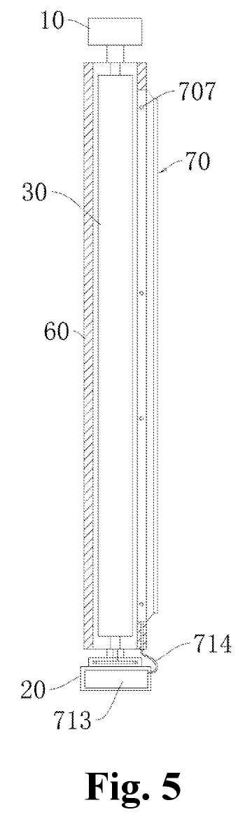

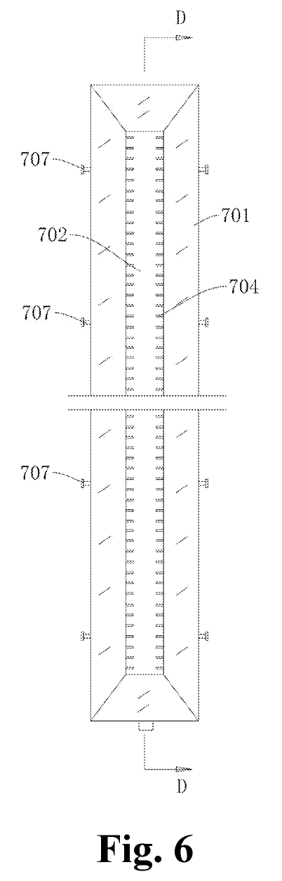

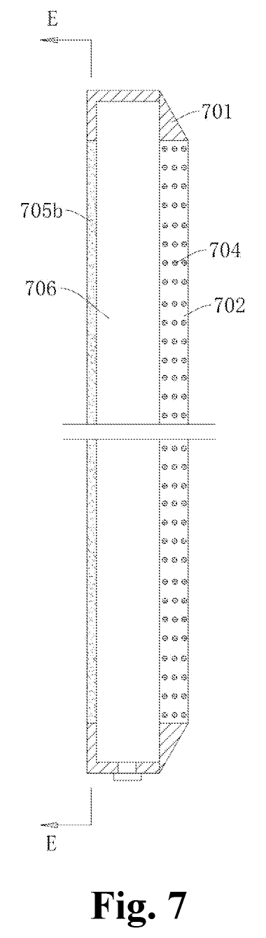

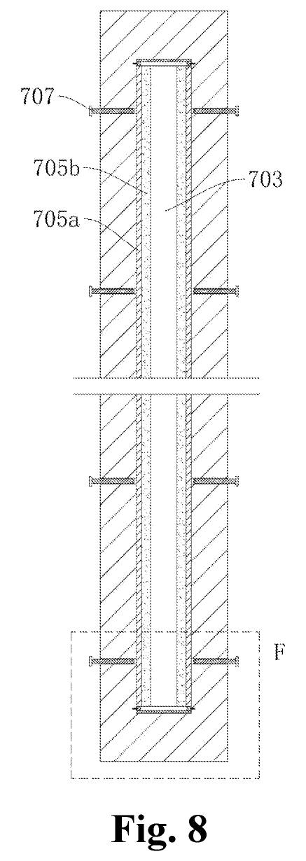

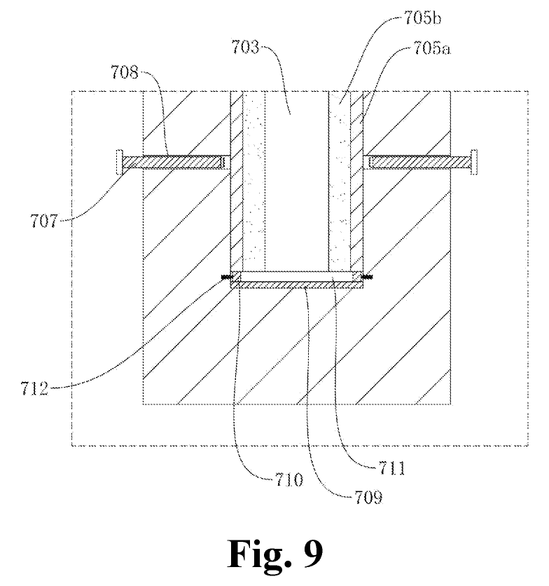

Further, referring to FIGS. 4-9, a housing 60 is arranged on an outer side of the rotating drum 30, wherein the upper fixed seat 10 and the lower fixed seat 20 are respectively mounted at two ends of the housing 60; and the housing 60 is provided with an opening, and a retraction brush assembly 70 is mounted at the opening.

The partition cloth 40, after retraction around the outer side of the rotating drum 30, is located in an inner cavity of the housing 60, and one end of the partition cloth 40 extends out from the opening of the housing 60 and passes through the retraction brush assembly 70.

When the partition cloth 40 extends out from the housing 60 or retracts into the housing 60, the retraction brush assembly 70 is arranged to sweep two side surfaces of the partition cloth 40 to remove dust and dissipate static electricity from the surface of the partition cloth 40.

Further, the retraction brush assembly 70 comprises:
a brush housing 701, mounted at the opening of the housing 60, wherein the brush housing 701 is provided with a first guide outlet 702 and a second guide outlet 703;
a first brush 704, mounted on two sides of an inner wall of the first guide outlet 702, wherein when the partition cloth 40 passes through the first guide outlet 702, ends of the first brush 704 contact and sweep two side surfaces of the partition cloth 40 to remove dust from the two side surfaces of the partition cloth 40;
a second brush 705, mounted on two sides of an inner wall of the second guide outlet 703, wherein when the partition cloth 40 passes through the second guide outlet 703, ends of the second brush 705 contact and sweep the two side surfaces of the partition cloth 40 to dissipate static electricity from the two side surfaces of the partition cloth 40;
an adjustment assembly, arranged on the brush housing 701, configured to adjust a distance between the two second brushes 705 on the inner wall of the second guide outlet 703; and
In this embodiment, the first brush 704 is an anti-static nylon brush; and the second brush 705 comprises a metal backplate 705a and a carbon fiber brush 705b mounted on the metal backplate 705a, wherein the metal backplate 705a is grounded via a metal component.

Further, the adjustment assembly comprises:
an adjustment bolt 707, penetrating through a threaded hole 708 on the brush housing 701 and facing a back surface of the second brush 705;
a guide rail 709, mounted at two ends of the inner wall of the second guide outlet 703;
a slider 710, fixed at the end of the second brush 705 and slidably engaged with a guide rail groove 711 on the guide rail 709;
a spring 712, wherein one end of the spring 712 is fixedly connected to a cavity wall of the inner cavity of the brush housing 701, and another end of the spring 712 is connected to the slider 710;
when rotating the adjustment bolts 707 on two sides of the brush housing 701 in a reverse direction, the ends of the adjustment bolts 707 are separated from the back surface of the second brush 705. When the pushing force is removed, the stretched spring 712 tends to reset and drive the two second brushes 705 to move away from each other. The gap between the two second brushes 705 increases, adapting to the partition cloths 40 of different thicknesses or materials, ensuring that the brushes closely contact the cloth surface, thereby enhancing cleaning and improving the static electricity dissipation effect.

Further, the dust suction assembly comprises a suction pump 713 arranged in the lower fixed seat 20, and a suction pipe 714 connected to the suction pump 713, and an end of the suction pipe 714 is in communication with the inner cavity 706 of the brush housing 701.

When the partition cloth 40 extends from or retracts into the housing 60, the partition cloth 40 passes through the first guide outlet 702 and the second guide outlet 703 of the retraction brush assembly 70. During deployment or retraction of the partition cloth 40, the retraction brush assembly 70 is arranged to sweep two side surfaces of the partition cloth 40 to remove dust and dissipate static electricity from the surface of the partition cloth 40. By providing the retraction brush assembly 70 (comprising a first brush 704 and a second brush 705), the brushes automatically clean both side surfaces of the partition cloth 40 during retraction or extension of the partition cloth 40, removing accumulated dust and neutralizing static electricity, thereby significantly reducing dust adhesion. The first brush 704 (an anti-static nylon brush) physically removes dust, while the second brush 705 (a carbon fiber brush with a metal backplate) dissipates static electricity via grounding, thereby enhancing cleaning efficacy through dual mechanisms.

The grounded metal backplate 705a of the second brush 705 rapidly discharges static electricity from the surface of the partition cloth 40, preventing electrostatic dust attraction. This design is particularly suitable for static-prone materials like rubber-coated partition cloths. The conductive properties of the carbon fiber brush further improve static electricity dissipation efficiency, reducing dust adhesion at the source.

The adjustment assembly, via cooperation between the springs 712 and the adjustment bolts 707, flexibly adjusts the spacing between the second brushes 705 to accommodate partition cloths 40 of varying thicknesses or materials. This thereby ensures tight contact between the brushes and the cloth surface, enhancing cleaning and improving the static electricity dissipation effect.

The dust collection assembly (comprising a suction pump 713 and a suction pipe 714) sucks in and centrally collects dust dislodged by the brushes, preventing secondary dispersion of dust, maintaining environmental cleanliness, and reducing manual cleaning frequency.

Moreover, the suction pump 713 is mounted on the lower fixed seat 20, increasing the weight of the lower fixed seat 20. When the entire gate barrier structure is placed on the ground, the lower fixed seat 20 rests on the ground. Due to the weight of the suction pump 713, the lower fixed seat 20 is stably supported on the ground without being prone to tipping.

The present disclosure retains the flexible partitioning function of conventional retractable gate barriers while significantly enhancing practicality and durability of the product through automated cleaning and static electricity dissipation design, particularly suitable for scenarios requiring long-term display or operating in high-dust environments.

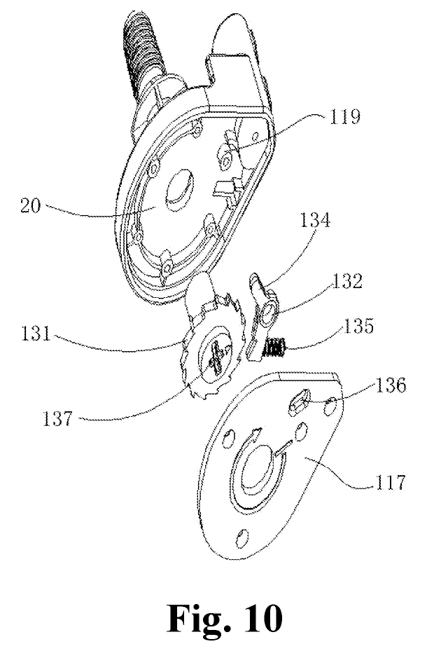

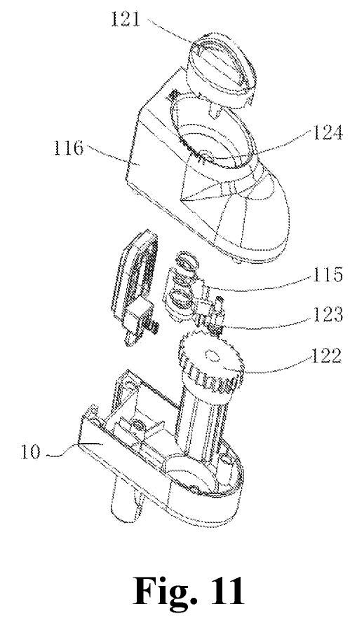

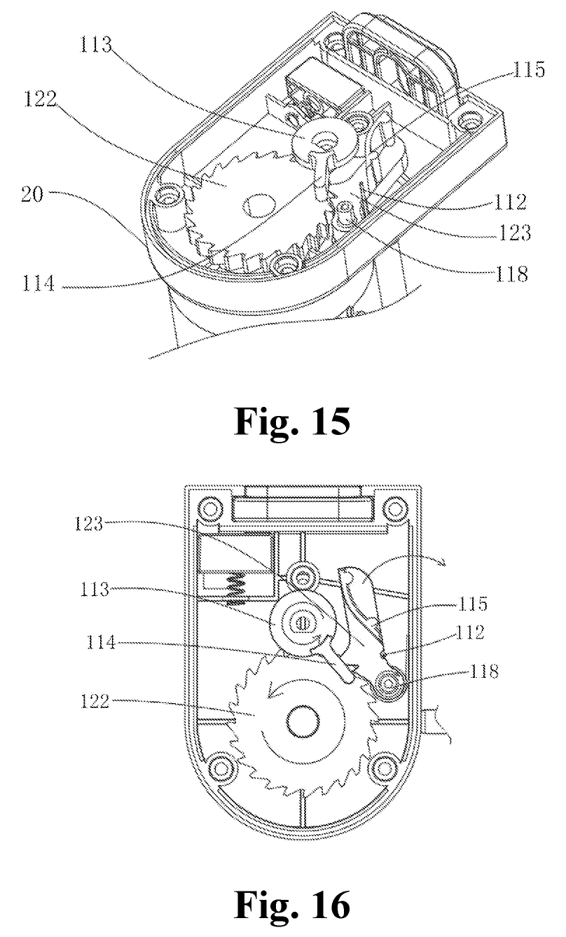

Further, referring to FIGS. 10-16, in some embodiments, the retractable gate barrier structure further comprises: an adjustment device, wherein the adjustment device comprises an adjustment rod 17 and an adjustment mechanism. One end of the torsion spring 50 is connected to the rotating drum 30. In this embodiment, the bottom end of the rotating drum 30 is provided with a lower mounting seat 18. The bottom end of the rotating drum 30 is detachably connected to the lower mounting seat 18. The lower mounting seat 18 is arranged in a limiting ring 19 protruding from the lower fixed seat 20, meaning the lower mounting seat 18 is rotatable relative to the lower fixed seat 20 about its own axis. One end of the torsion spring 50 is connected to the lower mounting seat 18, so that one end of the torsion spring 50 is connected to the drum 30. Another end of the torsion spring 50 is connected to the adjustment rod 17 of the adjustment mechanism. The adjustment mechanism is a unidirectional rotation mechanism configured to drive the adjustment rod 17 to rotate unidirectionally about a central axis of the adjustment rod 17. The adjustment rod 17 is configured to twist the torsion spring 50 via the unidirectional rotation of the adjustment rod 17, compressing the torsion spring 50, thereby increasing a torsional deformation amount of the torsion spring 50. In this embodiment, the adjustment mechanism adopts a ratchet mechanism as the unidirectional rotation mechanism. In other embodiments, users may select other options according to actual needs, for example, a one-way bearing, etc.

The adjustment mechanism is further described below, in this embodiment, the adjustment mechanism comprises:

A first abutting spring 135 abuts against one side of the adjustment pawl 132. The first abutting spring 135 is configured to bias the adjustment pawl 132 into engagement with a ratchet groove of the adjustment ratchet wheel 131. It is recognized in this adjustment mechanism that, due to the presence of the adjustment pawl 132, the adjustment ratchet wheel 131 can only rotate unidirectionally about its own axis, meaning the adjustment ratchet wheel 131 cannot rotate counterclockwise and then clockwise. In this embodiment, when twisting the adjustment ratchet wheel 131 to rotate counterclockwise, the adjustment ratchet wheel 131 drives the adjustment rod 17 to rotate counterclockwise. The unidirectional rotation of the adjustment rod 17 compresses the torsion spring 50, increasing a torsional deformation amount of the torsion spring 50 and enhancing a torsional elastic force of the torsion spring 50. To facilitate manual twisting of the adjustment ratchet wheel 131 with a tool, an adjustment groove 137 is formed on an outer side surface of the adjustment ratchet wheel 131. In this embodiment, the adjustment groove 137 is cross-shaped and engageable with a common cross screwdriver tool. In other embodiments, users may select alternative configurations according to actual needs, for example, a straight shape.

If a user needs to decrease a torsional deformation amount of the torsion spring 50 and reduce a torsional elastic force of the torsion spring 50, in this embodiment, an unlocking portion 134 protrudes from a side of the adjustment pawl 132. Upon manual pushing of the unlocking portion 134, the unlocking portion 134 drives the adjustment pawl 132 to disengage from a ratchet groove of the adjustment ratchet wheel 131. When the adjustment pawl 132 ceases to restrict the adjustment ratchet wheel 131, the adjustment ratchet wheel 131 stops exerting force on the torsion spring 50 through the adjustment rod 17. After removal of external force, the torsion spring 50 gradually returns to its original state, the torsional deformation amount of the torsion spring 50 gradually decreases, and the torsional elastic force of the torsion spring 50 gradually declines. When releasing the unlocking portion 134 to an unconstrained state, the first abutting spring 135 re-biases the adjustment pawl 132 into engagement with a ratchet groove of the adjustment ratchet wheel 131, preventing the torsion spring 50 from further reducing the torsional deformation amount. Through the above structural configuration, operational processes, and manual procedures, it is demonstrated that: the adjustment mechanism utilizes an inherent unidirectional rotation characteristic of the ratchet assembly to increase the torsional deformation amount of the torsion spring 50; and utilizes an inherent recovery characteristic of the torsion spring 50 after removal of external force to decrease the torsional deformation amount of the torsion spring 50, thereby satisfying actively user-adjustable control over the torsional deformation amount of the torsion spring 50.

In this embodiment, a lower end surface of the lower fixed seat 20 is provided with a sealing cover sealing the mounting cavity. The sealing cover is provided with a window hole 136 exposing the unlocking portion 134 to view. Through the window hole 136, the unlocking portion 134 inside the mounting cavity can be accessed for operation.

When a user pulls the separation cloth 40 out of the rotating drum 30 to a certain length and needs to lock the position of the separation cloth 40 to prevent the separation cloth 40 from being further pulled out from the rotating drum 30 by others, the locking can be accomplished with the aid of a locking device. The structure of the locking device is further described below. In this embodiment, the locking device is arranged in the upper fixed seat 10.

Further, the locking device comprises: a locking ratchet 122. The locking ratchet 122 is connected to an upper end of the rotating drum 30. In this embodiment, the locking ratchet 122 is provided with an upper mounting seat 126. The upper mounting seat 126 extends through a through hole provided in the upper fixed seat 10. The upper mounting seat 126 is configured to be rotatable relative to the upper fixed seat 10 about the axis of the upper mounting seat 126. With the aid of the upper mounting seat 126 and a lower mounting seat 18 provided at a bottom end of the rotating drum 30, the rotating drum 30 is configured to be rotatable about the axis of the rotating drum 30.

A locking pawl 123 is matched with the locking ratchet 122. The upper fixed seat 10 is provided with a rotating shaft 118, and the locking pawl 123 is sleeved on the rotating shaft 118 via a through-hole formed in the locking pawl 123.

One side of the locking pawl 123 abuts against a second abutting spring 112. The second abutting spring 712 is configured to bias the locking pawl 123 into engagement with a ratchet groove of the locking ratchet 122.

In this locking device, it can be understood that due to the limiting action of the locking pawl 123, the locking ratchet 122 can only rotate about the axis of the locking ratchet 122 in one direction, that is, the locking ratchet 122 cannot rotate clockwise after rotating counterclockwise. In this embodiment, when the locking pawl 123 is not engaged in a ratchet groove of the locking ratchet 122, the partition cloth 40 is arranged to be pulled out from the rotating drum 30. At this time, the rotating drum 30 rotates clockwise, and the locking ratchet 122 also rotates clockwise; the locking pawl 123 does not restrict the rotation of the locking ratchet 122. When it is necessary to lock the partition cloth 40 to prevent the partition cloth 40 from being further pulled out, the second abutting spring 112 can be used to cause the second abutting spring 112 to push the locking pawl 123 to engage a ratchet groove of the locking ratchet 122. The locking pawl 123 restricts the locking ratchet 122, preventing the locking ratchet 122 from continuing to rotate clockwise, thereby completing the action of preventing the partition cloth 40 from being further pulled out. Note that at this time, the locking pawl 123 does not restrict the locking ratchet 122 from rotating counterclockwise. A torsional force of the torsion spring 50 continuously applies a retracting force to the partition cloth 40. While the partition cloth 40 is restricted from being further pulled out, the partition cloth 40 remains in a taut state.

If the user needs to release the above locking of the partition cloth 40, an unlocking assembly can be used. The structure of the unlocking assembly is further described below. In this embodiment, the unlocking assembly comprises a push-off turntable 113 and a push-off protrusion 114 arranged on a side of the push-off turntable 113. The push-off turntable 113 is configured to rotate about an axis of the push-off turntable 113.

The locking pawl 123 is provided with a pushed portion 115 protruding therefrom, the push-off protrusion 114 is configured to be driven to rotate about the axis of the push-off turntable 113, and then the push-off protrusion 114 pushes the pushed portion 115, so that the pushed portion 115 rotates about an axis of the rotating shaft 118, thereby driving the locking pawl 123 to disengage from a ratchet groove of the locking ratchet 122 via the pushed portion 115, completing the release of the locking of the partition cloth 40.

In this embodiment, the upper fixed seat 10 is provided with a protective shell 116. The protective shell 116 is provided with a placement cavity 124 accommodating a locking knob 121. To facilitate the user's operation of the push-off protrusion 114, the locking knob 121 is connected to the push-off turntable 113.

In this embodiment, a pull-out end of the partition cloth 40 is covered with a protective shell 141. The protective shell 141 is provided with a corner-wrapping portion 142. The corner-wrapping portion 142 is used for wrapping and enclosing corner areas of the pull-out end of the partition cloth 40. By providing the protective shell 141 to protect the pull-out end of the partition cloth 40, the service life of the partition cloth 40 is effectively improved. Since corners of the partition cloth 40 are relatively prone to damage during use, the protective shell 141 is provided with the corner-wrapping portion 142 to wrap and protect the corners of the partition cloth 40, preventing damage to the corners of the partition cloth 40 after multiple uses, and further improving the service life of the cloth body.

Additionally, a support rod 150 parallel to the rotating drum 30 is arranged between the upper fixed seat 10 and the lower fixed seat 20. The support rod 150 is provided with a movable fixed seat 151. The movable fixed seat 151 can move back and forth along a length direction of the support rod 150. During installation of the retractable gate barrier, since there are only two fixed points at the top and bottom, stability in the middle may be insufficient, making the barrier prone to being pushed and damaged. Therefore, by providing the movable fixed seat 151, a fixed support can be formed in the middle of the retractable gate barrier, thereby improving installation stability.

Finally, it should be noted that the above embodiments are provided to illustrate the technical solutions of the present disclosure and are not intended to limit them; although the present disclosure has been described in detail with reference to the above embodiments, those skilled in the art should understand that the technical solutions recorded in the above embodiments may still be modified, or some or all of the technical features may be equivalently substituted; and such modifications or substitutions do not cause the essence of the corresponding technical solutions to depart from the scope of the technical solutions of the embodiments of the present disclosure.

What is claimed is:

1. A retractable gate barrier structure, comprising:
an upper fixed seat (10) and a lower fixed seat (20);
a rotating drum (30), arranged between the upper fixed seat (10) and the lower fixed seat (20), configured to rotate about an axis of the rotating drum (30);
a partition cloth (40), wound around the rotating drum (30), wherein a torsion spring (50) is arranged in the rotating drum (30), and the torsion spring (50) is configured to drive the rotating drum (30) to rotate about the axis of the rotating drum (30) in one direction, so that the rotating drum (30) is arranged to retract the partition cloth (40);
a housing (60), arranged on an outer side of the rotating drum (30), wherein the upper fixed seat (10) and the lower fixed seat (20) are respectively mounted at two ends of the housing (60); wherein the housing (60) is provided with an opening, and a retraction brush assembly (70) is mounted at the opening;
the partition cloth (40), after retraction around the outer side of the rotating drum (30), is located in an inner cavity of the housing (60), and one end of the partition cloth (40) extends out from the opening of the housing (60) and passes through the retraction brush assembly (70); and
when the partition cloth (40) extends out from the housing (60) or retracts into the housing (60), the retraction brush assembly (70) is arranged to sweep two side surfaces of the partition cloth (40) to remove dust and dissipate static electricity from the surface of the partition cloth (40).

2. The retractable gate barrier structure according to claim 1, wherein the retraction brush assembly (70) comprises:
a brush housing (701), mounted at the opening of the housing (60), wherein the brush housing (701) is provided with a first guide outlet (702) and a second guide outlet (703);
a first brush (704), mounted on two sides of an inner wall of the first guide outlet (702), wherein when the partition cloth (40) passes through the first guide outlet (702), ends of the first brush (704) contact and sweep two side surfaces of the partition cloth (40) to remove dust from the two side surfaces of the partition cloth (40);
a second brush (705), mounted on two sides of an inner wall of the second guide outlet (703), wherein when the partition cloth (40) passes through the second guide outlet (703), ends of the second brush (705) contact and sweep the two side surfaces of the partition cloth (40) to dissipate static electricity from the two side surfaces of the partition cloth (40);
an adjustment assembly, arranged on the brush housing (701), configured to adjust a distance between the two second brushes (705) on the inner wall of the second guide outlet (703); and
a dust suction assembly, mounted on the lower fixed seat (20), wherein the dust suction assembly is in communication with an inner cavity (706) of the brush housing (701).

3. The retractable gate barrier structure according to claim 2, wherein the first brush (704) is an anti-static nylon brush; and the second brush (705) comprises a metal backplate (705a) and a carbon fiber brush (705b) mounted on the metal backplate (705a), wherein the metal backplate (705a) is grounded via a metal component.

4. The retractable gate barrier structure according to claim 2, wherein the adjustment assembly comprises:
an adjustment bolt (707), penetrating through a threaded hole (708) on the brush housing (701) and facing a back surface of the second brush (705);
a guide rail (709), mounted at two ends of the inner wall of the second guide outlet (703);
a slider (710), fixed at the end of the second brush (705) and slidably engaged with a guide rail groove (711) on the guide rail (709);
a spring (712), wherein one end of the spring (712) is fixedly connected to a cavity wall of the inner cavity of the brush housing (701), and another end of the spring (712) is connected to the slider (710);
when rotating the adjustment bolts (707) on two sides of the brush housing (701) in a forward direction, ends of the adjustment bolts (707) are arranged to abut against a back surface of the second brush (705), so that the two second brushes (705) in the second guide outlet (703) close to each other and stretch the spring (712); and
when rotating the adjustment bolts (707) on two sides of the brush housing (701) in a reverse direction, the ends of the adjustment bolts (707) are separated from the back surface of the second brush (705), and the stretched spring (712) tends to reset and drive the two second brushes (705) to move away from each other.

5. The retractable gate barrier structure according to claim 2, wherein the dust suction assembly comprises a suction pump (713) arranged in the lower fixed seat (20), and a suction pipe (714) connected to the suction pump (713), and an end of the suction pipe (714) is in communication with the inner cavity (706) of the brush housing (701).

6. The retractable gate barrier structure according to claim 1, further comprising: an adjustment device, wherein the adjustment device comprises an adjustment rod (17), the torsion spring (50) and an adjustment mechanism, one end of the torsion spring (50) is connected to the rotating drum (30), and another end of the torsion spring (50) is connected to the adjustment rod (17); and
wherein the adjustment mechanism is a unidirectional rotation mechanism configured to drive the adjustment rod (17) to rotate unidirectionally about a central axis of the adjustment rod (17); and the adjustment rod (17) is configured to twist the torsion spring (50) via the unidirectional rotation of the adjustment rod (17), compressing the torsion spring (50), thereby increasing a torsional deformation amount of the torsion spring (50).

7. The retractable gate barrier structure according to claim 6, wherein the adjustment mechanism comprises:
an adjustment ratchet wheel (131), connected to the adjustment rod (17);
an adjustment pawl (132), matched with the adjustment ratchet wheel (131); the lower fixed seat (20) is provided with a mounting cavity, the adjustment ratchet wheel (131) and the adjustment pawl (132) are both arranged in the mounting cavity, and the adjustment ratchet wheel (131) is configured to rotate about an axis of the adjustment ratchet wheel (131); and the lower fixed seat (20) is provided with a rotating rod (119) protruding therefrom, and the adjustment pawl (132) is sleeved on the rotating rod (119) via a through-hole formed in the adjustment pawl (132); and
a first abutting spring (135), configured to bias the adjustment pawl (132) into engagement with a ratchet groove of the adjustment ratchet wheel (131).

8. The retractable gate barrier structure according to claim 7, further comprising a locking device, wherein the locking device is arranged in the upper fixed seat (10), and the locking device comprises:
a locking ratchet (122), connected to an upper end of the rotating drum (30);
a locking pawl (123), matched with the locking ratchet (122); and the upper fixed seat (10) is provided with a rotating shaft (118) protruding therefrom, and the locking pawl (123) is sleeved on the rotating shaft (118) via a through-hole formed in the locking pawl (123); and
a second abutting spring (112), configured to bias the locking pawl (123) into engagement with a ratchet groove of the locking ratchet (122).

9. The retractable gate barrier structure according to claim 8, wherein the locking device further comprises an unlocking assembly, the unlocking assembly comprises a push-off turntable (113) and a push-off protrusion (114) arranged on a side of the push-off turntable (113), and the push-off turntable (113) is configured to rotate about an axis of the push-off turntable (113); and
the locking pawl (123) is provided with a pushed portion (115) protruding therefrom, the push-off protrusion (114) is configured to be driven to rotate about the axis of the push-off turntable (113), and then the push-off protrusion (114) pushes the pushed portion (115), so that the pushed portion (115) rotates about an axis of the rotating shaft (118), thereby driving the locking pawl (123) to disengage from a ratchet groove of the locking ratchet (122) via the pushed portion (115).

10. The retractable gate barrier structure according to claim 9, wherein the upper fixed seat (10) is provided with a protective shell (116), the protective shell (116) is provided with a placement cavity (124) accommodating a locking knob (121), and the locking knob (121) is connected to the push-off turntable (113).
